(19) United States
(12) Patent Application Publication
(10) Pub. No.: US 2026/0200109 A1
(43) Pub. Date: Jul. 16, 2026

(54) KNIFE

(71) Applicant: 5.11, Inc., Manteca, CA (US)

(72) Inventors: Terry Serpa, South Pasadena, CA (US); Matthew David Noble, Long Beach, CA (US); Allen Philip Houghton, Huntington Beach, CA (US)

(21) Appl. No.: 19/450,146

(22) Filed: Jan. 15, 2026

Related U.S. Application Data
(60) Provisional application No. 63/745,780, filed on Jan. 15, 2025.

(51) Int. Cl. B26B 1/04

(52) U.S. Cl. CPC B26B 1/046

(57) ABSTRACT

A knife includes a body portion and a blade portion. The blade portion is movable between a closed position and an open position relative to the body portion. In the open position, the blade portion extends from a first end of the body portion. The body portion includes a shaped protrusion extending from the first end of the body portion and positioned parallel to and alongside the blade portion when the blade portion is in the open position. The shaped protrusion can allow the knife to be useful as a pry tool.

This application is related to and claims the benefit of U.S. Provisional Application Nos. 63/745,780, filed January 15, 2025, titled KNIFE, pending, the entirety of which is incorporated by reference herein and made a part of the present disclosure. Any and all applications for which a foreign or domestic priority claim is identified in connection with the present application are hereby incorporated by reference herein and made a part of the present disclosure.

### BACKGROUND

### FIELD

The present disclosure generally relates to a knife having additional functionality beyond simply having a cutting blade. In particular, the present disclosure relates to a knife having a knife body that includes a pry tool, which adds a pry functionality to increase the functionality of the knife when the blade is not in use.

### DESCRIPTION OF RELATED ART

Examples of a knife including a pry tool or pry feature exist. However, some previous attempts have generally located the pry tool at the end of the knife opposite the end from which the blade is deployed.

### SUMMARY

Locating the pry tool on the same end as the blade allows the user a more natural hand position when using the pry tool and frees up the opposite end for additional features, if desired. Specific shaping of the pry end can provide for added functionality, as well. The addition of a pry tool to the blade end of the knife body creates a unique feature set that allows for the same or better usability relative to the use of each of the blade and the pry tool individually, or at least provides the public with a useful choice.

The systems, methods, and devices described herein have innovative aspects, no single one of which is indispensable or solely responsible for their desirable attributes. Without limiting the scope of the claims, some of the advantageous features will now be summarized.

An aspect of the present disclosure involves a knife including a body portion and a blade portion. The blade portion is movable between a closed position and an open position relative to the body portion. In the open position, the blade portion extends from a first end of the body portion. The body portion includes a shaped protrusion extending from the first end of the body portion and positioned parallel to and alongside the blade portion when the blade portion is in the open position.

In some configurations, the shaped protrusion tapers in thickness in a direction from the first end of the body portion towards or to an end surface of the shaped protrusion.

In some configurations, a first surface of the protrusion closest to the blade portion is non-tapered and a second surface of the protrusion furthest from the blade portion is tapered towards a tip of the blade portion when the blade portion is in the open position and wherein the first surface and the second surface define the thickness of the protrusion.

In some configurations, the shaped protrusion tapers in width in the direction from the first end of the body portion towards or to the end surface of the shaped protrusion.

In some configurations, an angle between a lower lengthwise edge and the end surface of the shaped protrusion is greater than an angle between an upper lengthwise edge and the end surface of the shaped protrusion.

In some configurations, an upper corner of the shaped protrusion includes a chamfer.

In some configurations, the chamfer has a length of between about 1.0-5 mm, about 1.5-3.0 mm, or about 1.75-2.5 mm, or wherein the length of the short edge 103 is about 2.0 mm.

In some configurations, the end surface has a length between about 5-20 mm, about 7-18 mm, about 10-15 mm, or about 12-13 mm, or wherein the length is about 12.5 mm.

In some configurations, a length of the shaped protrusion is between about 10-25 mm, about 10-20 mm, about 12-18 mm, or about 14-16 mm, or wherein the length of the shaped protrusion is about 15 mm.

In some configurations, the body portion comprises a first side portion and a second side portion.

In some configurations, the blade portion is pivotally connected to the body portion

In some configurations, the knife includes a locking mechanism configured to lock the blade portion in the open position.

In some configurations, the locking mechanism is a frame lock.

In some configurations, the protrusion comprises a textured surface finish on an outer facing surface.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several embodiments in accordance with the disclosure and are not to be considered limiting of its scope, the disclosure will be described with additional specificity and detail through the use of the accompanying drawings.

FIG. 1 is a front view of an embodiment of a knife with the blade in the open position.

FIG. 2 is a front view of the knife with the blade in the closed position.

FIG. 3 is a rear view of the knife with the blade in the open position.

FIG. 4 is a rear view of the knife with the blade in the closed position.

FIG. 5 is a top view of the knife with the blade in the open position.

FIG. 6 is a top view of a portion of the knife with the blade in the closed position emphasizing the pry tool.

FIG. 7 is a front view of an embodiment of a knife with the blade in the open position.

FIG. 8 is a front view of the knife of FIG. 7 with the blade in the closed position.

### DETAILED DESCRIPTION

A knife is a useful piece of equipment for cutting objects. Knife blades have a specific function, as a result of which they are made from specific materials and have a specific

thickness and a sharpened edge. While the profile of a knife blade may lend itself to being used as a pry tool, the blade material and sharpened edge may not. Using the blade as a pry tool can be dangerous and could result in injury or a broken knife. Adding a specific pry tool to the knife body provides the knife with the additional functionality of a pry tool in a safe manner without use of the blade. Furthermore, the knife body can be constructed from a material suitable for use as a pry tool. Additionally, locating the pry tool on the end from which the knife blade is deployed allows for the handle to be of a shape that would be well adapted to use of the knife blade and the use of the pry tool because the knife body is held relative to the user’s hand in the same lengthwise direction in either use case.

Embodiments of the knife are described with reference to the accompanying figures, wherein like numerals refer to like or similar elements throughout. Although several embodiments, examples, and illustrations are disclosed below, it will be understood by those of ordinary skill in the art that the inventions described herein extends beyond the specifically disclosed embodiments, examples, and illustrations, and can include other uses of the inventions and obvious modifications and equivalents thereof. The terminology used in the description presented herein is not intended to be interpreted in any limited or restrictive manner simply because it is being used in conjunction with a detailed description of certain specific embodiments of the inventions. In addition, embodiments of the inventions can comprise several novel features and no single feature is solely responsible for its desirable attributes or is essential to practicing the inventions herein described.

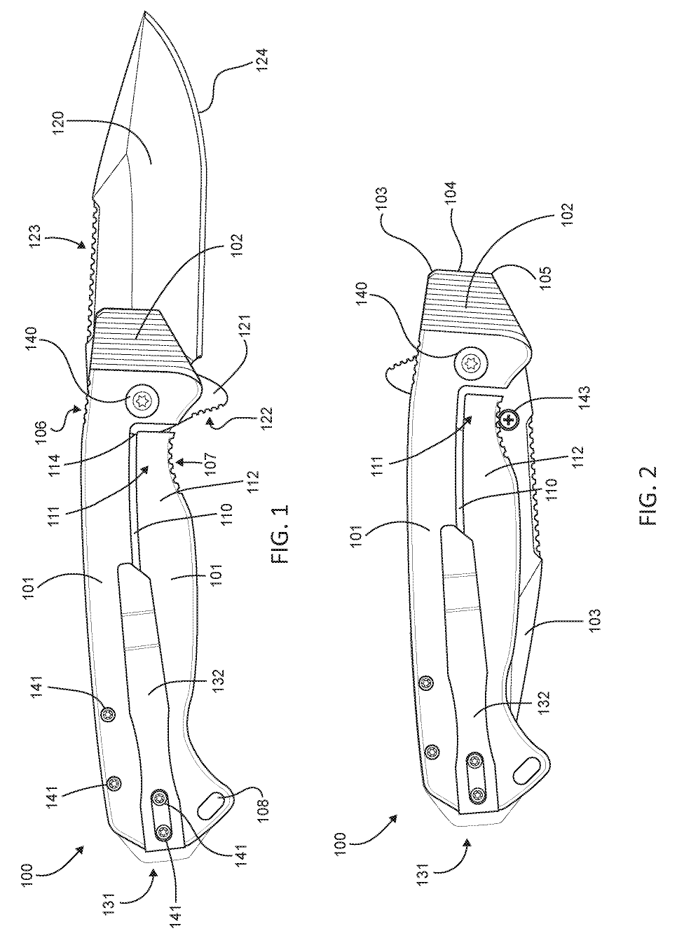

FIGS. 1–6 illustrate an embodiment of the knife 100 having a pry tool in accordance with certain features, aspects, and advantages of the present disclosure. The knife 100 includes a body portion, or a body, and a blade portion, or a blade 120. The body portion of the illustrated knife 100 is constructed of multiple pieces or components. In particular, the body portion includes a first body portion 101, a second body portion 130, and a spacer portion 131. However, the body portion could also be formed as a single piece or single integrated structure. The illustrated knife 100 also includes an attachment clip 132, which allows the knife 100 to be secured (clipped) to a relatively thin object, such as a pocket.

As described previously, the body portion can be an assembly of several pieces. These pieces can be permanently or removably coupled. In the illustrated arrangement, the first body portion 101, the second body portion 130, and the spacer portion 131 are coupled to one another with the spacer portion 131 located between the first body portion 101 and the second body portion 130.

The first body portion 101, the second body portion 130, and the spacer portion 131 are secured to one another with at least one fastener 141, which can be a removable fastener. The first body portion 101 and the second body portion 130 can be separately secured to the spacer portion 131. In some configurations, one or more of the fasteners (e.g., fastener 141) can couple all three of the first body portion 101, the second body portion 130, and the spacer portion 131.

The blade portion 120 is positioned in a space defined by and/or located between the first body portion 101 and the second body portion 130. The blade portion 120 is rotatably supported on a pivot pin 140 to move between a stowed or a closed position and a deployed or an open position. The pivot pin 140 can also be used to connect the first body portion 101 and the second body portion 130. In some configurations, the pivot pin 140, along with the fastener(s) 141, may be removable to allow the component parts of the knife 100 to be separated to aid in repair or cleaning functions. Alternatively, the pivot pin 140 and the removable fastener(s) 141 could be substituted with a permanent attachment method or with a different removable fastening arrangement.

With continued reference to FIGS. 1–6, the second body portion 130 may include additional features to increase the users grip such as, but not limited to, shaved down areas, textured surfaces, grip features, etc.

The spacer portion 131 may be constructed with one of an arrays of possible shapes and one or more of an arrays of possible materials to provide desired functionality to the user. Typically, the spacer portion 131 will have a thickness that is similar to, or slightly greater than, the thickness of the blade portion 120 to provide suitable space between the first body portion 101 and the second body portion 130 to accommodate the blade portion 120 when stowed and to allow for movement of the blade portion 120 between the stowed and deployed positions. The pivot pin 140 can also space the first body portion 101 and the second body portion 130 a proper distance apart to accommodate the blade portion 120.

The first body portion 101 may include one of an array of possible shapes and one or more of an array of possible materials to provide additional functionality to the user. The first body portion 101 may include features to increase the users grip, such as thumb jimping 106 and grip jimping 107, as well as features on the first body portion 101 such as shaved down areas, textured surfaces, grip features, etc. Optionally, the first body portion 101 may possess a lanyard loop 108 configured to receive a lanyard (not shown), which may aid the user with deployment of the knife 100 when it is stowed away when not in use.

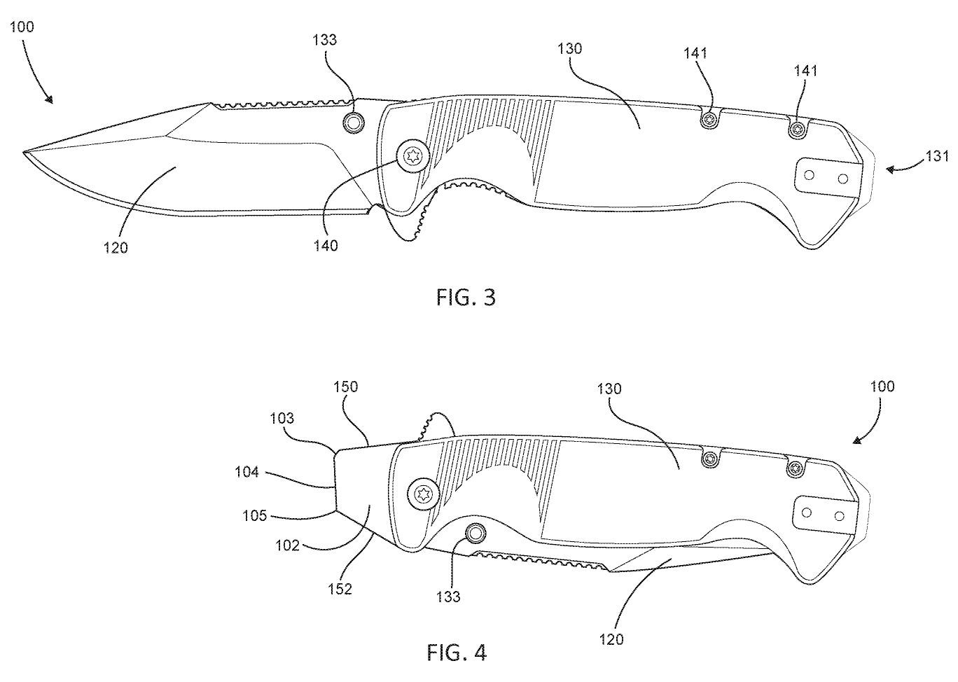

FIGS. 1, 3, and 5 illustrate the blade portion 120 of the knife 100 in an open, or deployed, position. The blade portion 120 is rotatable engaged between the open, or deployed, position and the closed, or stowed, position, as shown in FIGS. 2 and 4. In the open position, the blade portion 120 extends outwardly from and parallel to the first body portion 101 and/or the second body portion 130. In the closed position, the blade portion 120 extends inwardly relative to and sits alongside the first body portion 101 and/or the second body portion 130 and is housed between the first body portion 101 and the second body portion 130. The blade portion 120 includes a sharpened blade edge 124. The illustrated blade portion 120 and blade edge 124 are merely by way of example. The blade portion 120 and blade edge 124 may be a various sizes and shapes specific to the desired functionality of the knife 100. The blade portion 120 may also include blade jimping 123. The blade portion 120 may have a flipper tab 121 that may include tab jimping 122, which may add additional texture for increased grip and usability for the user. The blade portion 120 may include a thumb stud 133 (FIGS. 3 and 4), which may be fastened to the blade portion 120 by a flush fastener 143 (FIG. 2). In some configurations, the flush fastener 143 is removable to allow the thumb stud 133 to be removed from the blade portion 120 to aid in repair or cleaning functions. Alternatively, the flush fastener 143 could be substituted with a permanent attachment method or with a different removable fastening option.

With reference to FIGS. 1, 2 and 5, the knife 100 can include a blade lock mechanism 111. An embodiment of the blade lock mechanism 111 can include the first body portion 101 comprising a split 110 that defines a flexible tab 112. The flexible tab 112 is configured to be biased inwards towards the center of the knife 100 such that when the blade portion 120 is in an open position, the blade portion 120 is substantially locked in the open position. When the blade portion 120 is in the open position, the biasing force of the flexible tab 112 causes the flexible tab 112 to extend inwards towards the center of the knife 100 and contact or be positioned adjacent to an end 114 of the blade portion 120. The flexible tab 112 can contact the end 114 of the blade portion 120 to inhibit or prevent the blade portion 120 from rotating towards or to the closed position. To allow the blade 120 to rotate to the closed position, a user can place an outward force on the flexible tab 112 until the flexible tab 112 is in alignment with the rest of the first body portion 101, or at least out of alignment with the blade portion 120, thus allowing the blade portion 120 to fold inward. The force required to flex the flexible tab 112 can be tuned to a desired force by adjusting the geometry of the split 110 or the thickness of the first body portion 101. In the illustrated arrangement, the flexible tab 112 is structurally formed with the first body portion 101; however, in other embodiments the flexible tab 112 may be a separate structure and attached to the first body portion 101. Such an arrangement could be advantageous by allowing the stiffness of the flexible tab 112 to be different than the first body portion 101 by choosing a different material. The above-described locking mechanism 111 can be described as a frame lock.

As will be appreciated by one skilled in the art, the knife 100 can incorporate a variety of different lock mechanisms instead of or in addition to the flexible tab 112. Other lock mechanisms can include a liner lock, a back lock, a compression lock, an axis lock, a button lock, a slipjoint, a ball bearing lock, a ram-safe lock, a virobloc, a lever lock, a rolling lock, or any other type of knife lock.

FIGS. 1–6 illustrate an embodiment of the body portion of the knife 100. In the illustrated arrangement, the first body portion 101 includes a shaped protrusion 102 extending from the first body portion 101. However, in other arrangements, the second body portion 130 could include the shaped protrusion 102. In configurations that have a single piece body portion or otherwise do not include separate body portions 101, 130, the shaped protrusion 102 can be formed by or otherwise coupled to the body portion on one side of the blade portion 120. In the illustrated arrangement, the shaped protrusion 102 is formed as a unitary structure with the body portion of the knife 100 or the portion of the body portion from which the shaped protrusion 102 extends (e.g., the first body portion 101). However, in other arrangements, the shaped protrusion 102 could be a separate piece from the body portion of the knife 100 and could be coupled thereto by any suitable arrangement, such as mechanical fastener(s).

In the illustrated arrangement, the shaped protrusion 102 extends from the first body portion 101 on the same end as the blade portion 120 when the blade portion 120 is in the open or deployed position. The shaped protrusion 102 extends from the first body portion 101 in a direction parallel to the blade portion 120. The shaped protrusion 102 extends beyond the blade portion 120 when the blade portion 120 is in the closed or stowed position. When the blade portion 120 is in the open position, it partially or fully covers the shaped protrusion 102. The shaped protrusion 102 extends beyond a corresponding end of the second body portion 130 or beyond a portion of the body portion on a side of the blade portion 120 opposite the shaped protrusion 102. With such an arrangement, with the blade portion 120 in the closed position, the shaped protrusion 102 extends beyond adjacent structures of the knife 100 such that the knife 100 does not have any structures on one or more sides of the shaped protrusion 102. Preferably, the knife 100 does not have any structures on all sides of the shaped protrusion 102. Accordingly, the shaped protrusion 102 is useful as a pry tool without interference from other portions of the knife 100.

The shaped protrusion 102 may have one of a variety of shapes, textures, surface finishes, and thicknesses based on the desired functionality. FIGS. 1–6 illustrate one possible profile of the shaped protrusion 102 as an example. An end portion of the shaped protrusion 102 can include a short edge 103, a long edge 104, and a pointed edge 105. The short edge 103 is defined by a chamfer between an upper lengthwise edge 150 of the shaped protrusion 102 and the long edge 104, which defines an end surface of the shaped protrusion 102. The pointed edge 105 is formed by a sharp corner between a lower lengthwise edge 152 of the shaped protrusion 102 and the long edge 104. The long edge extends between the short edge 103 and the pointed edge 105.

The numbers of edges on the shaped protrusion 102 may vary in quantity and would correspond with the desired features and functionality. The short edge 103 may be used for a plethora of needs, some examples of which include a pry edge or a flat head screwdriver. Similarly, the long edge 104 may be used as similar tools, but in circumstances that may require a longer edge or larger surface area for optimal performance. The pointed edge 105 may be used as slicing edge to cut packing tape to open packaging. The pointed edge 105 is capable of cutting packing tape, but advantageously is less likely to damage contents of the packaging in comparison to the blade edge 124.

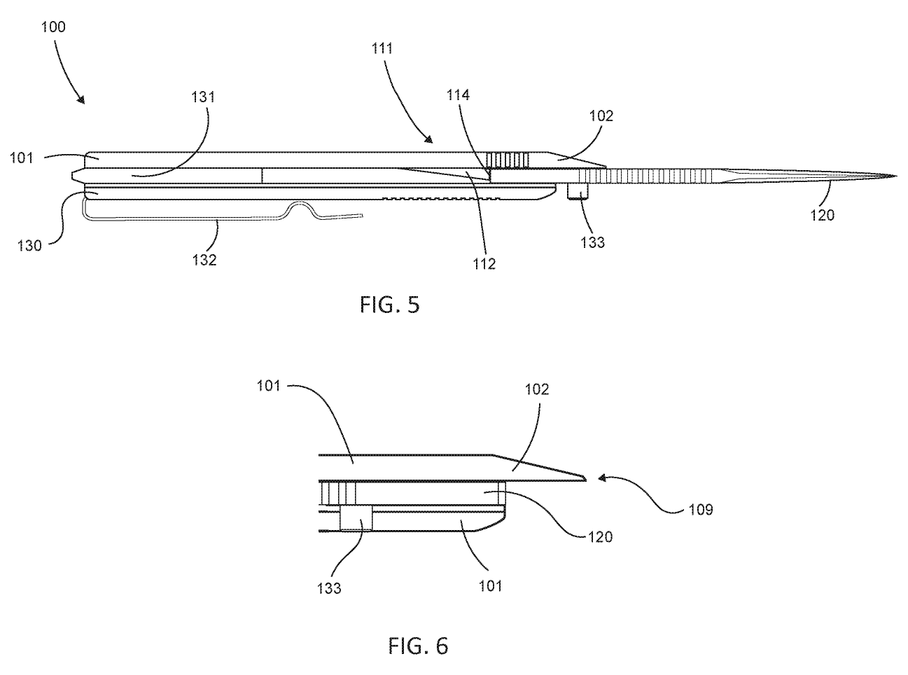

FIG. 6 illustrates the shaped protrusion 102 with a profiled shape 109 that forms a wedge to facilitate the pry tool functionality. That is, the wedge form of the profiled shape 109 allows the shaped protrusion 102 to enter gaps of various widths. The tip of the shaped protrusion 102 can be of a sufficiently narrow width to allow the shaped protrusion 102 to operate as a slotted screwdriver. As illustrated in FIG. 6, the shaped protrusion 102 decreases in thickness in a direction extending away from the body portion of the knife 100 towards or to the long edge 104. This decrease in thickness forms the wedge profiled shape 109. The decrease in thickness can be linear, resulting in a flat outward-facing surface of the shaped protrusion 102, or could be non-linear resulting in, for example, a curved outward-facing surface. In the illustrated arrangement, the outward-facing surface of the shaped protrusion 102 is provided with a textured surface finish, which can provide the shaped protrusion 102 with increased grip. The textured surface finish can be provided by the process used to form the shaped protrusion 102, such as machining of the metal material that forms the shaped protrusion 102 (and, in the illustrated arrangement, the first body portion 101). However, the textured surface finish could be formed by other methods, as well, or could be omitted.

As illustrated in FIGS. 1, 2, and 4, the shaped protrusion 102 can have a tapered shape when viewed from the side of the knife 100. That is, a width of the shaped protrusion 102 can decrease in the direction extending away from the body portion of the knife 100 towards or to the long edge 104. The shaped protrusion 102 can be asymmetrical when viewed from the side of the knife 100. In the illustrated arrangement, an angle between the lower lengthwise edge 152 of the shaped protrusion 102 and the long edge 104 is greater than an angle between the upper lengthwise edge 150 of the shaped protrusion 102 and the long edge 104. As a result, the long edge 104 is off-center in a height direction of the knife 100 such that the upper end of the long edge 104 is located closer to an upper edge of the knife 100 in comparison to a distance between the lower end of the long edge 104 and a lower edge of the knife 100. In some configurations, the long edge 104 has a forward tilt from the lower end to the upper end of the long edge 104 such that the short edge 103 is located forward of the pointed edge 105.

The shaped protrusion 102 can have one of a variety of shapes and dimensions selected to provide the knife 100 with desirable attributes. In some configurations, the long edge 104 can have a length between about 5-20 mm, about 7-18 mm, about 10-15 mm, or about 12-13 mm. In some configurations, the length of the long edge 104 is about 12.5 mm. A thickness of the shaped protrusion 102 at the tip or at the long edge 104 can be between about 0.5-2.0 mm, about 0.5-1.5 mm, or about 0.5-1.0 mm. In some configurations, the thickness of the shaped protrusion 102 at the tip or at the long edge 104 can be about 0.8 mm. The short edge 103 can have a length between about 1.0-5 mm, about 1.5-3.0 mm, or about 1.75-2.5 mm. In some configurations, the length of the short edge 103 is about 2.0 mm. A length of the shaped protrusion 102 can be between about 10-25 mm, about 10-20 mm, about 12-18 mm, or about 14-16 mm. In some configurations, the length of the shaped protrusion is about 15 mm. Such dimensions allow the shaped protrusion 102 to provide useful pry tool functionality without unduly interfering with the functionality of the knife 100 or making the knife too long when the blade portion 120 is in the closed or stowed position. However, other dimensions could also be used.

The shaped protrusion 102 can have a length that is be about 5% - about 15% of the length of the first body portion 101 or the second body portion 130. In other embodiments, the shaped protrusion 102 can have a length that is about 10% - about 25% of the length of the first body portion 101 or the second body portion 130. In other embodiments, the shaped protrusion 102 can have a length that is about 3% - about 15% of the length of the first body portion 101 or the second body portion 130. In some embodiments the shaped protrusion 102 can have a length that is about 12% of the length of the first body portion 101 or the second body portion 130. Furthermore, in some embodiments, the long edge 104 can have a width that is about 40% - about 60% of the widest width of the first body portion 101 or the second body portion 130. In other embodiments, the long edge 104 can have a width that is about 20% - about 80% of the widest width of the first body portion 101 or the second body portion 130. In other embodiments, the long edge 104 can have a width that is about 50% - about 100% of the widest width of the first body portion 101 or the second body portion 130. In some embodiments, the long edge 104 can have a width that is about 52 % of the widest width of the first body portion 101 or the second body portion 130. The described length and width percentages can also be applicable comparable to the length and width of the blade portion 120.

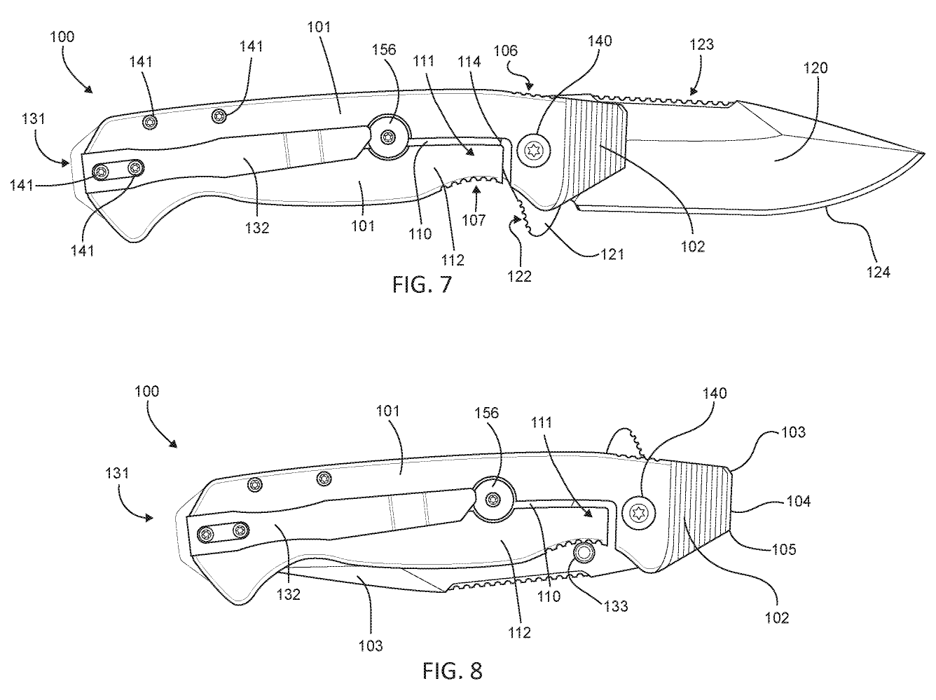

FIG. 7 and FIG. 8 illustrate another embodiment of a knife 100. The knife 100 is similar in many respects to the knife 100 described above and is described below with an emphasis on the differences relative to the previously-described knife 100. Therefore, features of the knife 100 can be the same as or similar to the corresponding features of the other embodiments described herein, or can be of another suitable arrangement.

FIG. 7 and FIG. 8 illustrate an embodiment of the knife with the addition of an over travel limiter 156. The over travel limiter 156 can be configured to restrain or prevent excessive outward movement of the flexible tab 112 when a user applies an outward force to the flexible tab 112 in order to allow the blade portion 120 to be rotated to the closed position. Such an arrangement can be particularly advantageous by allowing the flexible tab 112 to have a relatively low stiffness thus requiring a relatively low outward force to be required to close the knife 100. Thus, with the addition of the over travel limiter 156, the flexible tab 112 can have a low stiffness while preventing it from being damaged or overextended by a user.

### Conclusion

It should be emphasized that many variations and modifications may be made to the herein-described embodiments, the elements of which are to be understood as being among other acceptable examples. All such modifications and variations are intended to be included herein within the scope of this disclosure and protected by the following claims. Moreover, any of the steps described herein can be performed simultaneously or in an order different from the steps as ordered herein. Moreover, as should be apparent, the features and attributes of the specific embodiments disclosed herein may be combined in different ways to form additional embodiments, all of which fall within the scope of the present disclosure.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment.

Moreover, the following terminology may have been used herein. The singular forms “a,” “an,” and “the” include plural referents unless the context clearly dictates otherwise. Thus, for example, reference to an item includes reference to one or more items. The term “ones” refers to one, two, or more, and generally applies to the selection of some or all of a quantity. The term “plurality” refers to two or more of an item. The term “about” or “approximately” means that quantities, dimensions, sizes, formulations, parameters, shapes and other characteristics need not be exact, but may be approximated and/or larger or smaller, as desired, reflecting acceptable tolerances, conversion factors, rounding off, measurement error and the like and other factors known to those of skill in the art. The term “substantially” means that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

Numerical data may be expressed or presented herein in a range format. It is to be understood that such a range format is used merely for convenience and brevity and thus should be interpreted flexibly to include not only the numerical values explicitly recited as the limits of the range, but also interpreted to include all of the individual numerical values or sub-ranges encompassed within that range as if each numerical value and sub-range is explicitly recited. As an illustration, a numerical range of “about 1 to 5” should be interpreted to include not only the explicitly recited values of about 1 to about 5, but should also be interpreted to also include individual values and sub-ranges within the indicated range. Thus, included in this numerical range are individual values such as 2, 3 and 4 and sub-ranges such as “about 1 to about 3,” “about 2 to about 4” and “about 3 to about 5,” “1 to 3,” “2 to 4,” “3 to 5,” etc. This same principle applies to ranges reciting only one numerical value (e.g., “greater than about 1”) and should apply regardless of the breadth of the range or the characteristics being described. A plurality of items may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. Furthermore, where the terms “and” and “or” are used in conjunction with a list of items, they are to be interpreted broadly, in that any one or more of the listed items may be used alone or in combination with other listed items. The term “alternatively” refers to selection of one of two or more alternatives, and is not intended to limit the selection to only those listed alternatives or to only one of the listed alternatives at a time, unless the context clearly indicates otherwise.

What is claimed:

1. A knife, comprising:
a body portion; and
a blade portion that is movable between a closed position and an open position relative to the body portion, wherein in the open position the blade portion extends from a first end of the body portion;
wherein the body portion comprises a shaped protrusion extending from the first end of the body portion and positioned parallel to and alongside the blade portion when the blade portion is in the open position.

2. The knife of claim 1, wherein the shaped protrusion tapers in thickness in a direction from the first end of the body portion towards or to an end surface of the shaped protrusion.

3. The knife of claim 2, wherein a first surface of the protrusion closest to the blade portion is non-tapered and a second surface of the protrusion furthest from the blade portion is tapered towards a tip of the blade portion when the blade portion is in the open position and wherein the first surface and the second surface define the thickness of the protrusion.

4. The knife of claim 2, wherein the shaped protrusion tapers in width in the direction from the first end of the body portion towards or to the end surface of the shaped protrusion.

5. The knife of claim 1, wherein an angle between a lower lengthwise edge and an end surface of the shaped protrusion is greater than an angle between an upper lengthwise edge and the end surface of the shaped protrusion.

6. The knife of claim 1, wherein an upper corner of the shaped protrusion includes a chamfer.

7. The knife of claim 5, wherein the chamfer has a length of between about 1.0-5 mm, about 1.5-3.0 mm, or about 1.75-2.5 mm, or wherein the length of a short edge 103 is about 2.0 mm.

8. The knife of claim 4, wherein the end surface has a length between about 5-20 mm, about 7-18 mm, about 10-15 mm, or about 12-13 mm, or wherein the length is about 12.5 mm.

9. The knife of claim 4, wherein a length of the shaped protrusion is between about 10-25 mm, about 10-20 mm, about 12-18 mm, or about 14-16 mm, or wherein the length of the shaped protrusion is about 15 mm.

10. The knife of claim 1, wherein the body portion comprises a first side portion and a second side portion.

11. The knife of claim 1, wherein the blade portion is pivotally connected to the body portion.

12. The knife of claim 10, wherein the knife includes a locking mechanism configured to lock the blade portion in the open position.

13. The knife of claim 11, wherein the locking mechanism is a frame lock.

14. The knife of claim 1, wherein the protrusion comprises a textured surface finish on an outer facing surface.
